(19) United States
(12) Patent Application Publication
(10) Pub. No.: US 2006/0157214 A1
(43) Pub. Date: Jul. 20, 2006

(54) Method of preventing raveling of surface of paper body in paper machine, printing paper for offset printing, and mold releasing agent

(76) Inventor: Hiroshi Sekiya, Ota-ku (JP)

Correspondence Address: FLYNN THIEL BOUTELL & TANIS, P.C., 2026 RAMBLING ROAD, KALAMAZOO, MI, 49008-1631, US

(21) Appl. No.: 10/546,345

(22) PCT Filed: Feb. 18, 2004
(86) PCT No.: PCT/JP04/01821

§ 371 Date: Feb. 21, 2006

(30) Foreign Application Priority Data
Feb. 18, 2003 (JP) 2003-039577

(51) Int. Cl. D21F 1/10; D21F 3/08; D21F 5/00; C04B 35/66; B28B 7/38

(52) U.S. Cl. 162/199; 106/38.22; 106/38.24; 106/38.25

(57) ABSTRACT

A method of preventing the raveling of the surface of a paper body in a paper making step, particularly in a press part and a dry part, of a paper machine, and a mold releasing agent used for the method and capable of effectively preventing the raveling of the surface of the paper body, the method wherein the mold releasing agent is provided to the member of the paper machine in direct contact with the paper body in the press part and/or the dry part of the paper machine to prevent the raveling of the surface of the paper body when the paper body is separated from that member to lower a surface strength. The method is also applicable to a wire part. Since the suitable mold releasing agent is provided to the member in direct contact with the paper body in the press part and the dry part of the paper machine, the raveling of the surface of the paper body can be prevented to prevent the lowering of the surface strength of the paper body.

### TECHNICAL FIELD

The present invention relates to a method for preventing fuzz of a paper body in a paper machine and a release agent used in the method, and in particular to a method for preventing surface strength from lowering due to raveling of a surface of a paper body in a press part, a dry part or a wire part in a paper machine, and release agent.

### BACKGROUND ART

The usage of paper product presently extends to many fields, and high qualities are required in respective application fields.

Further, offset printing presently predominates instead of relief printing, and high printability such as excellent ink impressibility, color polychrome printability which does not cause color unevenness, printing opacity, printing workability and the like is required even in a conventional field of printing papers.

An offset printing process is a printing process which supplies dampening water and ink to a lithographic plate having a lipophilic image line portion and a hydrophilic non-image line portion to perform printing.

More specificially, printing on a printing paper is performed by once transferring the ink adhered to an image line portion on a lithographic plate (PS plate) from the image line portion to a rubber plate so-called “blanket” and further transferring the ink from the blanket to a paper.

As ink used in the offset printing, ink having relatively high tack (viscosity) is usually used for such a reason that water resistance is given to the ink.

Therefore, when surface strength of a printing paper is weak, such a phenomenon that a surface of the paper finely peels off due to tack of the ink occurs, which causes various problems in printability of the paper.

For example, when a surface of printing paper finely peels off, fine fibers, fillers or the like release to be mixed in ink, which causes such a problem that so-called squeeze-out occurs on a printing face.

Further, the fine fibers, fillers and the like released form paper dusts on a blanket or the like to deposit thereon (blanket piling), and when printing is conducted without change, a torus-shape void (hikky), amorphous void (spot) or the like is caused on a printing face of paper.

Therefore, it is necessary to frequently clean the blanket or the like, which results in considerable obstruction to printing workability.

Furthermore, in recent years, waste paper material from waste newspaper or the like is blended in a row material for paper product at a high rate in the view of waste reduction, resource saving or the like, so that many vessels unique to broad leaf tree pulp from advertising catalogs are mixed into a printing paper.

Since the vessels are poor in binding property with other material pulps, the vessels are peeled off from paper surface easily due to viscosity of ink for offset printing when a surface strength of printing paper is weak, so that voids (vessel picks) occur in printed image (see Patent Literature 1, for example).

Further, dampening water together with ink is also transferred to a paper in the offset printing.

Therefore, for example, in polychrome printing conducted by offset printing, dampening water moistens printing paper in printing for a first color so that surface strength of the paper lowers.

When printing for a second color is performed, a problem may occur of a wet pick where ink for the second color is not transferred to the paper sufficiently or ink for the first color is peeled off so that ink impressibility deteriorates.

In order to prevent such events from occurring, various application of surface treating agents (sizing agent, sheet strength enhancing agent, etc.) is performed to printing paper.

In order to prevent such a trouble at an offset printing time, it is necessary to increase surface strength of paper and impart water resistance to the paper.

Therefore, for example, starch, polyvinyl alcohol (PVA), polyacrylamide (PAM) or the like is often applied to paper surface in a field of newsprint paper or the like.

However, when an application amount of starch or the like becomes excessive, adherence (so-called “neppari” in Japanese wording) of paper surface increases and print paper adheres on a blanket, which may result in such a running trouble that wrinkles occur in a paper or a paper breaks.

Further, surface treating agent relatively poor in water resistance such as polyacrylamide (PAM) itself melts out in a dampening water during offset printing so that the agent together with paper dusts deposits on a blanket or the like (see Patent Literature 2, for example).

Thus, such surface treating agent develops its effect more effectively according to increase its dosage, but since the adherence increases or blanket piling occurs correspondingly, it can not be said necessarily that the agent is effective surface treating agent.

Further, though many other surface treating agents have been developed, any surface treating agent which can solve all the above problems and whose load to environment is reduced with a low cost has not been found at least presently.

In the offset printing, a cause of such a problem as blanket piling or dry pick or wet pick such as vessel pick, such as described above mainly lies in that a surface strength of a printing paper is weak to tack of ink.

Further, for example, even in a case of a coated paper, when surface strength of base paper for the coat paper itself is weak, even if a coat layer is formed on the surface of the base paper, the coat layer is defeated by ink with high viscosity for offset printing, so that the surface of the base paper may peel off together with the coat layer.

Accordingly, in order to solve the above problem, as described above, it is also important to apply a surface treating agent, but attention should be paid to strengthening surface strength itself of printing paper, namely, examining factors lowering surface strength of a printing sheet in a papermaking step in the paper machine and improving and overcoming such a factor if any.

However, there is an actual situation that a technique invented from such a viewpoint has been hardly disclosed.

Regarding literatures describing a method for manufacturing printing paper in relation to the offset printing, some methods for manufacturing printing paper which associates a paper making step with a soft calendering processing in order to solve an obverse and reverse difference regarding smoothness of paper and ink impressibility due to the smoothness have been proposed (see Patent Literatures 3 and 4).

Further, regarding the problem of the vessel pick, there is a report that many vessel picks occur on a so-called wire face (reverse face) side of printing paper and peeling-off of vessels can be suppressed by strengthening squeezing of the wire face side in a first press of a press part in a paper machine (see Patent Literature 5).

In the same Literature, it is estimated as the reason that, when wet paper is squeezed using felt or the like, binding property among fibers of material pulp is strengthened on the squeezed side face of the paper so that peeling-off of vessels can be suppressed effectively.

In recent years, however, there are many structures for a paper machine, and there are also many paper machines of a type where, after a wire face of wet paper (printing paper) is brought in pressure contact with felt in a first press of a press part, the paper is pressed directly by press rolls in second and third presses.

It is one finding that, when a wet paper is squeezed using felt or the like, a binding force among fibers of material pulp is strengthened so that surface strength is improved, but there is not any disclosure about influence given when the wire face is pressed directly by the press roll.

Further, there is not any consideration about influence given to the surface strength when the material pulp is heated and dried by a dryer roll in a dry part of the paper machine.

Patent Literature 1: JP-A-2002-294587

Patent Literature 2: JP-A-10-259591

Patent Literature 3: JP-A-11-1891

Patent Literature 4: JP-A-2002-88690

Patent Literature 5: JP-A-2002-115192

### DISCLOSURE OF INVENTION

(Problem to be Solved by the Invention)

The present invention has been made in order to overcome the above problems in view of these circumstances.

That is, an object of the present invention is to provide a method for preventing raveling on paper body surface (namely, deterioration of surface strength) in a paper-making step, especially, in a press part or a dry part, in a paper machine.

Further, another object of the invention is to provide release agent which is used in the method to allow effective prevention of raveling on paper body surface.

(Means for Solving the Problem)

Thus, as a result of keen repeated researches to such a problem background, the present inventors have found such a fact that raveling on a surface of the paper body in a paper machine occurs especially at time point when the paper body is separated from a roll or canvas coming in direct contact with the paper body in the press part or the dry part, and raveling on the paper body surface can be prevented and deterioration of surface strength of the paper body can be prevented by applying proper release agent to the roll coming in direct contact with the paper body or the like, and they have completed the present invention based upon this finding.

That is, (1): the present invention lies in a method for preventing raveling on a paper body surface, where release agent is applied to a member which comes in direct contact with a paper body in a press part and/or a dry part in a paper machine and surface strength is prevented from deteriorating due to raveling on the paper body surface occurring when the paper body separates from the member.

(2): The present invention lies in a method for preventing raveling on a paper body surface, where release agent is applied to a member which comes in direct contact with a paper body in a wire part in a paper machine and surface strength is prevented from deteriorating due to raveling on the paper body surface occurring when the paper body separates from the member.

(3): The present invention lies in a method for preventing raveling on a paper body surface, where release agent is applied to a press roll which comes in direct contact with a paper body in a press part in a paper machine and surface strength is prevented from deteriorating due to raveling on the paper body surface occurring when the paper body separates from the press roll.

(4): The present invention lies in a method for preventing raveling on a paper body surface, where release agent is applied to a dryer roll and/or a canvas which comes in direct contact with a paper body in a dry part in a paper machine and surface strength is prevented from deteriorating due to raveling on the paper body surface occurring when the paper body separates from each of the above-described members.

(5): The present invention lies in a method for preventing raveling on a paper body surface, where release agent is applied to a press roll which comes in direct contact with a paper body in a press part in a paper machine, release agent is applied to a dryer roll and/or a canvas which comes in direct contact with a paper body in a dry part in the paper machine, and surface strength is prevented from deteriorating due to raveling on the paper body surface occurring when the paper body separates from each of the above-described members.

(6): The present invention lies in a method for preventing raveling on a paper body surface described in claim 4 or 5, where above-described dryer roll is a dryer roll with which the paper body first comes in direct contact.

(7): The present invention lies in a method for preventing raveling on a surface of a paper body described in claim 4 or 5, where above-described dryer roll is a heated dryer roll with which the paper body first comes in direct contact.

(8): The present invention lies in a method for preventing raveling on a paper body surface described in claim 4 or 5, where above-described canvas is a canvas with which the paper body first comes in direct contact.

(9): The present invention lies in a method for preventing raveling on a paper body surface described in claims 1 to 8, where above-described paper body is a printing paper for offset printing.

(10): The present invention lies in a printing paper for offset printing manufactured using the method for preventing raveling on a paper body surface described in claims 1 to 9.

(11): The present invention lies in release agent used in the method for preventing raveling on a paper body surface described in claims 1 to 9, where a main component of the release agent to be applied is wax, emulsion of oil, aqueous solution of polymer, or mixture of these materials.

(12): The present invention lies in release agent described in claim 11, where above-described oil is silicone oil.

(13): The present invention lies in release agent described in claim 11, where above-described oil is vegetable oil, mineral oil, synthetic oil, or mixture thereof.

(14): The present invention lies in release agent described in claim 11, where above-described polymer is ampholyte copolymer obtained by polymerizing mixture including cationic monomer having ethylene double bond and anionic monomer having ethylene double bond as essential components.

(15): The present invention lies in release agent described in claim 14, where above-described cationic monomer is monomer having ethylene double bond with amino groups, ammonium base, or quaternary ammonium base.

(16) The present invention lies in release agent described in claim 14, where the anionic monomer is monomer having ethylene double bond with carboxyl groups or alkali metal salt thereof.

(17) The present invention lies in release agent described in claim 11, where above-described polymer is ampholyte copolymer obtained by polymerizing mixture including cationic monomer having ethylene double bond, anionic monomer having ethylene double bond, and non-ionic (nonion) monomer as essential components.

(18) The present invention lies in release agent described in claim 15, where above-described cationic monomer is at least one selected from the group consisting of compounds which are (meta) acrylic esters such as (meta) acrylic acid 2-(N,N-dimethylamino)ethylmethylchloride salt, (meta) acrylic acid 2-(N,N-dimethylamino)ethylbenzylchloride salt, and (meta) acrylic acid 3-(N,N-dimethylamino)propylepichlorohydrin hydrochloride and which contain quaternary ammonium chlorine.

(19) The present invention lies in release agent described in claim 16, where above-described anionic monomer is at least one selected from the group consisting of acrylic acid, methacrylic acid, itaconic acid, fumaric acid, succinic acid 2-(meta)acrylicoiloxyethyl, and hexahydrophthalate 2-(meta)acrylicoiloxyethyl.

(20) The present invention lies in release agent described in claim 17, where the number of atoms is in a range of 6 to 50 in above-described non-ionic (nonion) monomer.

(21) The present invention lies in release agent described in claim 17, where above-described non-ionic (nonion) monomer is polyethyleneglycolmono(meta)acrylate and/or polypropyleneglycolmono(meta)acrylate.

The present invention can adopt any constitution obtained by combining two or more selected from the above items 1 to 21, if it satisfies the object, of course.

(Effect of the Invention)

According to the present invention, proper release agent is applied to a member (a press roll, a dryer roll, canvas, or wire) coming in direct contact with a paper body in a press part or a dry part in a paper machine, so that raveling on a surface of a paper body can be prevented and surface strength of the paper body can be prevented from deteriorating.

Further, by implementing the method for preventing raveling on a surface of a paper body according to the present invention in both the press part and a dryer part simultaneously in parallel, surface strength of a paper body can be reliably prevented from deteriorating.

Furthermore, by using ampholyte copolymer obtained by polymerizing mixture of cationic monomer having ethylene double bond and anionic monomer having ethylene double bond as release agent, further excellent raveling preventing effect an be expected.

### BRIEF DESCRIPTION OF THE DRAWINGS

FIG. 1 is a schematic diagram showing a constitution example of a press part and a dry part in a paper machine;

FIG. 2 is a schematic diagram showing a case that a single canvas system is adopted for a first group of the dry part in the constitution example shown in FIG. 1;

FIG. 3 is an enlarged view of a portion of the press part in the paper machine shown in FIG. 1;

FIGS. 4(a) and 4(b) are schematic views showing a fuzz state on a paper body surface, FIG. 4(a) showing a state where the paper body surface does not include fuzz and FIG. 4(b) showing a state where the paper body surface is fuzzed;

FIG. 5 is an enlarged view of a section in the vicinity of a press roll P4t shown in FIG. 1;

FIG. 6 is an enlarged view of a section in the vicinity of a dry roll D1 in the paper machine shown in FIG. 1;

FIG. 7 is a graph showing experimental results;

FIG. 8 shows results of additional experiment; and

FIG. 9 is a diagram showing a wire part and a press part.

### BEST MODE FOR CARRYING OUT THE INVENTION

A method for preventing raveling on a paper body surface according to the present invention will be explained with reference to the drawings showing preferred embodiments.

As described above, surface strength of a paper body depends on a binding property among fibers of material pulp, and the surface strength becomes strong when fibers bind tightly together, while the surface strength becomes weak when binding among fibers looses (namely, raveling).

In research performed by the present inventors, it has been found that a possibility that paper body surface ravels in a paper-making step lies in a press part where a paper body is pressed against a roll in a state that it still contains much moisture or an upstream side of a dry part where the paper body is pressed against heated roll or canvas in a state that it contains much moisture.

As the result of a further detailed analysis, it has been also found that, when the paper body containing much moisture separates from the roll or canvas with which the paper body is brought in direct pressure contact, the paper body sticks to the roll or the like and fibers in the vicinity of a surface of the paper body are pulled by such a member as a roll, so that raveling occur on the paper body surface, which results in deterioration of the surface strength.

Incidentally, in a final stage of the dry part in the paper machine where drying of a paper body has progressed considerably, raveling do not occur on the paper body surface any more except for such a case that paper dusts or the like adhere to the dryer roll so that the roll becomes very sticky.

As described in detail below, therefore, the present invention is characterized in that a member coming in direct contact with a paper body, such as roll or a wire, is applied with proper release agent in the press part, the dry part, or the wire part in the paper machine, and releasability of a paper body to the member is elevated so that raveling on the paper body surface is prevented from occurring and surface strength of the paper body is maintained and strengthened.

Further, it is preferable that the method for preventing raveling on a paper body surface of the present invention is performed in both of the press part and the dry part simultaneously in parallel, because deterioration of the surface strength of the paper body can be prevented more reliably.

Furthermore, by performing such a method on a felt face (so-called obverse side of a paper body) and a wire face of paper body (so-called reverse side of a paper body), raveling on the paper body surface can be prevented regarding the obverse and reverse sides of the paper body, so that the surface strength of the paper body can be maintained and strengthened totally.

In an actual paper machine, however, because of a structure thereof or the like, raveling hardly occurs on one side of a paper body but a surface of the paper body considerably ravels on the other side thereof so that a difference in surface strength of a paper body between the obverse side and the reverse side may occur.

In such a case, the difference between the obverse side and the reverse side can be solved by selectively applying a method for preventing raveling on a paper body surface of the present invention described later to a face whose surface strength is weak (a face of a paper body ravels easily) to apply release agent to a press roll or a dry roll coming in direct contact with the face.

[Press Part and Dry Part in Paper Machine]

In a paper machine, conventionally, after a paper body is dehydrated in a wire part, it is squeezed and dehydrated by a press roll in a press part, and it is fed to a dry part where the paper body is heated and dried.

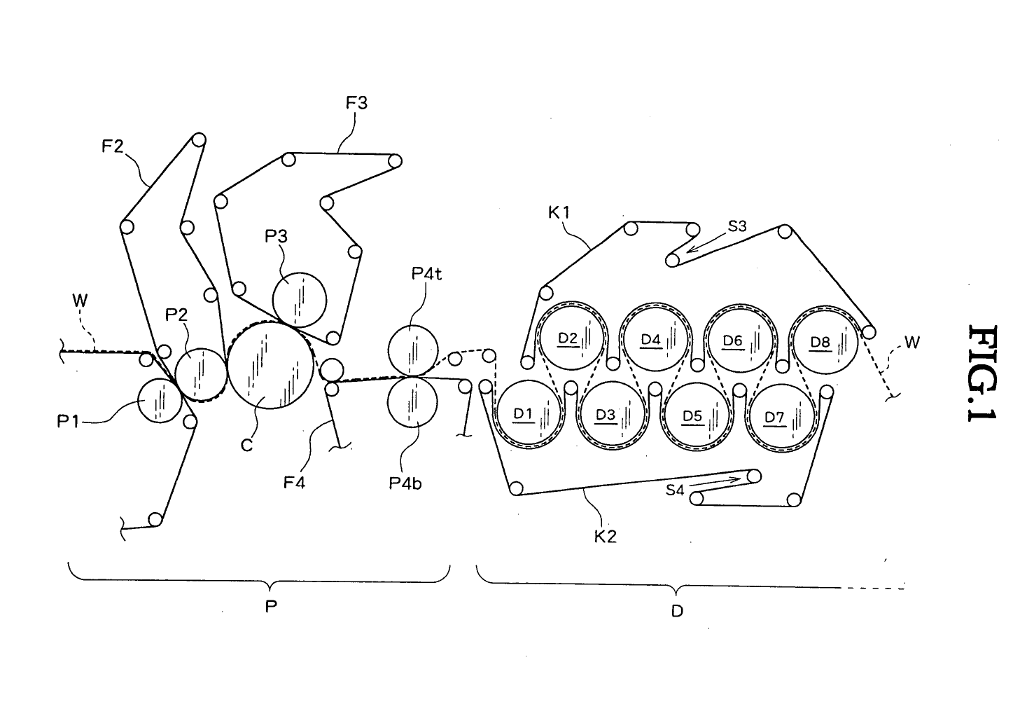

FIG. 1 is a schematic diagram showing a constitution example of a press part and a dry part in a paper machine.

In FIG. 1, a wire face of a paper body W is a lower face of the paper body W, while a felt face thereof is an upper face.

In this constitution example, a press part P is constituted of press rolls P1, P2, P3, P4t and P4b, a center roll C which is a kind of a press roll, felts F2 to F4, and the like.

Further, a first group of a dry part D is applied with a so-called “double canvas system”, and it is constituted of dryer rolls D1 to D8 and canvases K1 and K2 disposed above and below, and the like.

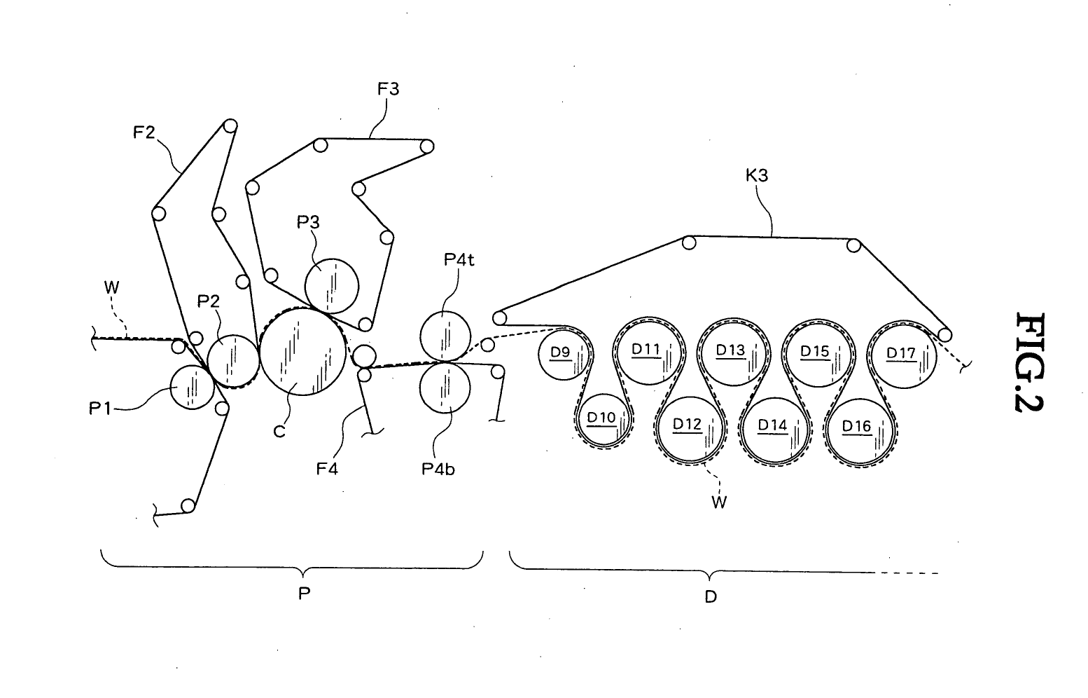

Incidentally, a so-called “single canvas system” may be adopted for the first group of the dry part D depending on a kind of a paper to be made, as shown in FIG. 2.

After the paper body W enters in the press part P, it is squeezed by the press rolls P1 and P2 in a state that it has been sandwiched between the wire w and the felt F2.

Next, the paper body W is conveyed by the felt F2 and it is squeezed together with the felt F2 by the press roll P2 and the center roll C.

The paper body W is further squeezed together with the felt F3 by the press roll P3 and the center roll C in a state that it has come in contact with the center roll C.

In this constitution example, the press rolls P4t and P4b are provided as a fourth press, and the paper body W is squeezed together with the felt F4 by the press rolls P4t and P4b.

Accordingly, in the press part P in this constitution example, the wire face of the paper body W is brought in direct pressure contact with the center roll C, and the felt face is brought in direct pressure contact with the press roll P4t.

The paper body W is further conveyed to dry part D and it is moved between the respective dryer rolls in such a state that it has been pressed onto the dryer rollers D1 to D8 by the canvases K1 and K2, so that it is heated and dried.

Therefore, in the dry part Din this constitution example, the wire face of the paper body W is brought in direct pressure contact with the dryer rollers D2, D4, D6, and D8 in the upper stage, and canvas K2 in the lower stage, while the felt face is brought in direct pressure contact with the dryer rollers D1, D3, D5, and D7 in the lower stage, and the canvas K1 in the upper stage.

[Occurrence Mechanism of Raveling in Press Part]

Next, occurrence mechanism of raveling on a paper body surface in the press part will be explained.

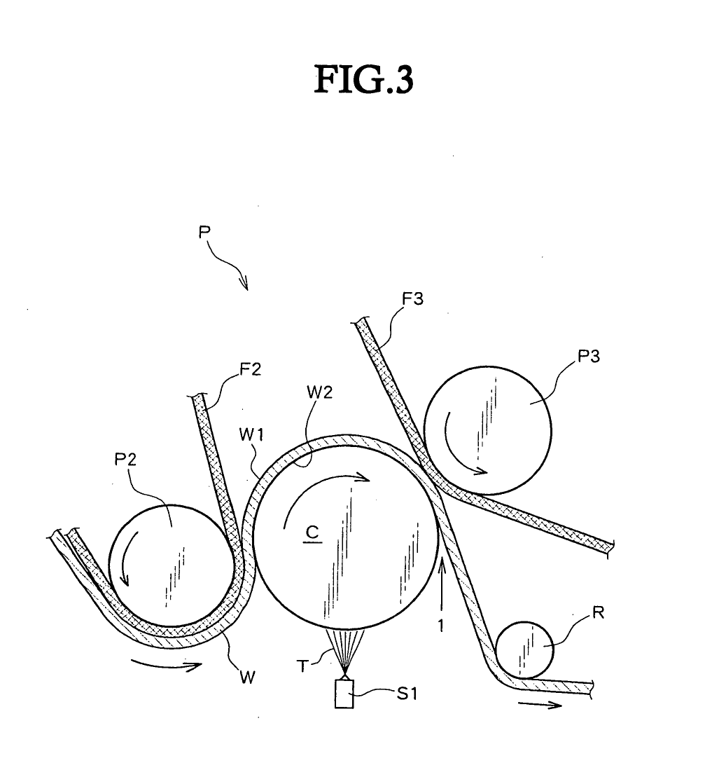

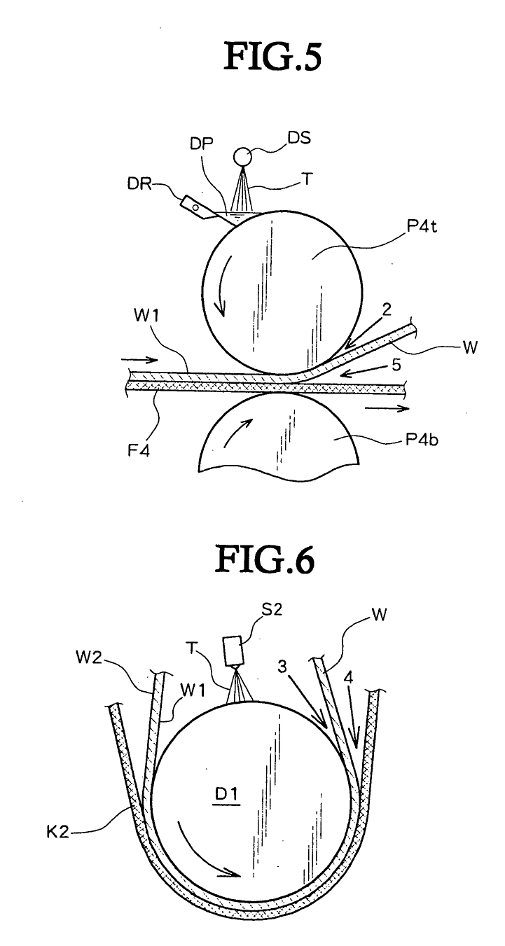

FIG. 3 is an enlarged view of a portion of the press part in the paper machine shown in FIG. 1 (the paper body W, and the felt F2 and F3 have been conveniently illustrated in an emphatic manner as compared with actual ones. Hereinafter, the same is applied to FIG. 5).

As described above, in the press part P, the paper body W is strongly tightened by a nip pressure between the respective press rolls, so that moisture in the paper body W is absorbed and dehydrated by the felt. Simultaneously therewith, binding among fibers in the paper body W is strengthened.

In examination about the process made in detail based upon an example where a paper body W is squeezed between the press roll P2 and center roll C, the following matter has been found.

Since moisture in a paper body W is absorbed from a felt face W1 side of paper bodywby a felt F2, dehydration progresses in the vicinity of the felt face W1 in the paper body W so that fiber organization is tightened.

However, since a nip pressure between the press rolls is applied to the paper body W only instantaneously, moisture in the vicinity of the wire face W2 of the paper body W is not sufficiently dehydrated necessarily.

On the contrary, since the paper body W contains relatively much moisture in the vicinity of the wire face W2 and it is strongly pressed to the center roll C while binding among fibers in the vicinity of the wire face W2 is in loosened state, the paper body adheres to the center roll C with some degree of force.

Such dehydration and adhesion are repeated even in the next dehydration between the press roll P3 and the center roll C.

Therefore, the paper body W adheres to the center roll C relatively strongly while the wire face W2 side contains relatively much moisture and binding among fibers is not strengthened.

The paper body W is pulled out of the center roll C at a paper releasing position 1 as it is.

At that time, fibers of the paper body W in the vicinity of the wire face W2 thereof are pulled by the center roll C and the wire face W2 ravels, so that surface strength of the wire face W2 deteriorates.

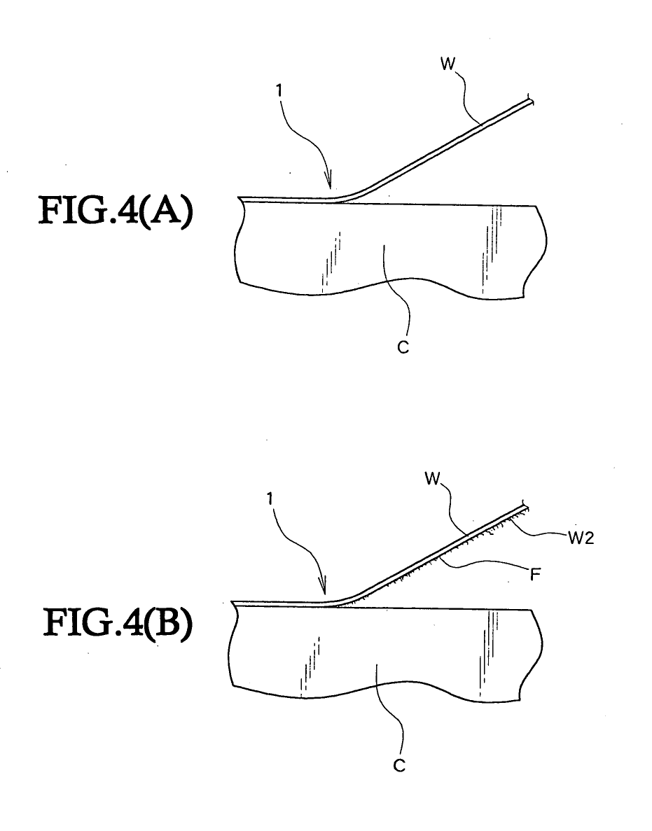

When the center roll C has been contaminated by transferring of pitches, fine fibers, fillers and the like on the surface of the paper body W to the center roll C, adhesive force between the paper body W and the center roll C becomes more strength, so that fibers F may float up from the wire face W2 of paper body, so-called fuzz may occur, as shown in FIG. 4(b).

When such a state is caused, surface strength of the wire face W2 becomes very weak.

Incidentally, FIG. 4(a) shows a state that the paper body W separates from the center roll C in an ideal manner and no fuzz occurs.

On the other hand, the felt face W1 of the paper body W comes in direct pressure contact with the press roll P4t.

In this constitution example, the felt face W1 of the paper body W is preliminarily dehydrated to a certain extent in respective nip pressures between the press rolls P1 and P2, between the press roll P2 and the center roll C, and between the press roll P3 and the center roll C.

However, the paper body W contains relatively much moisture even in this stage, and when the paper body W is tightened with a strong nip pressure between the press rolls P4t and P4b to be strongly pressed on to the press roll P4t, as shown in FIG. 5, the felt face W1 of the paper body W sticks to the press roll P4t with a certain degree of force like the above.

Then, when the paper body W separates from the press roll P4t at a paper releasing position 2, fibers in the vicinity of the felt face W1 are pulled by the press roll P4t so that raveling occurs on the felt face W1, which results in deterioration of a surface strength like the case of the wire face.

Such a case may occur that the paper body W entered in the press part sticks to the felt F2, F3, or F4.

In such a case, when the paper body W separates from the felt F4 at a paper releasing position 5 (see FIG. 5) like the case of P4t, the wire face W2 of the paper body W is pulled by the felt F4 and raveling occurs on the wire face W2, which results in deterioration of surface strength.

[Occurrence Mechanism of Raveling in Dry Part]

There is a possibility that raveling on a paper body surface occurs even in the dry part.

Here, the mechanism will be explained briefly.

FIG. 6 is an enlarged view of a section in the vicinity of the dryer roll D1 in the paper machine shown in FIG. 1 (the paper body W and the canvas K2 have been conveniently illustrated in an emphatic manner as compared with actual ones).

The paper body W is heated and dried in the dry part, and binding property among fibers is further strengthened in the course of the heating and drying, so that a paper product can be obtained.

However, since the paper body W squeezed in the press part, which has just entered in the dry part still contains much moisture, when it is pressed on to the dryer roll D1 heated by the canvas K2, a so-called instantaneous burning-out occurs, so that the paper body W sticks to the dryer roll D1 with a certain degree of force. Further, in the paper body W just entered in the dry part, binding among fibers is still weak.

Therefore, like the case of the press roll described previously, when the paper body W separates from the dryer roll D1 and the canvas K2 at a paper releasing position 3, the felt face W1 of the paper body W is pulled and raveling occurs on the felt face W1, which results in deterioration of surface strength.

The paper body W entered in the dry part may stick to the canvas K2.

In such a case, when the paper body W separates from the canvas K2 at a paper releasing position 4 (see FIG. 6), the wire face W2 of the paper body W is pulled and raveling occurs on the wire face W2, which results in deterioration of surface strength like the case of the above dryer roll D1.

Further, pitches, fine fibers, or the like are easily transferred from the paper body W where binding among fibers is weak to the dryer roll D1 and the canvas K2.

Therefore, there is such a case that adhesive materials such as pitches are sequentially transferred to the dryer roll D1 and the canvas K2 so that they are deposited on surfaces thereof.

Especially, since sticky property of sticky material deposited on the surface of the dryer roll D1 increases due to its heat, the felt face W1 coming in direct contact with the direr roll D1 becomes easy to ravel. In an extreme case, a surface may fuzz finely (see FIG. 4(b)).

There is a possibility that such raveling or fuzzing occur even on the dryer rolls D3, D5, and D7 of the other lower stage shown in FIG. 1.

Regarding the dryer rolls D2, D4, D6, and D8 in the upper stage, a positional relationship between the felt face W1 and the wire face W2 of the paper body W to the dryer rolls and the canvas K1 is reversed from the above, but there is a possibility that ravels and fuzzes occur according to the same mechanism as the above.

Further, raveling or the like may occur even on the canvas K1 in the same manner.

[Method for Preventing Raveling on Paper Body Surface]

As described above, from the research conducted by the present inventors, it has been found that, in the paper machine, especially, in the press part or the drypart where much moisture is still contained in a paper body, fibers in the vicinity of the felt face or the wire face of the paper body are pulled at the paper releasing positions where the paper body separates from the press roll, the direr roll, or the canvas with which the paper body has been brought in direct pressure contact by such a member as the press roll and raveling occurs on the paper body surface, which may result in deterioration of surface strength.

In view of these circumstances, the method for preventing raveling on a paper body surface according to the present invention is constituted such that raveling is prevented from occurring on a paper body surface by applying release agent to a member coming in direct contact with a paper body in the press part or the dry part in the paper machine such that a member such as the press roll does not pull fibers in the vicinity of the felt face or the wire face of paper body.

More specifically, release agent is applied to the press roll with which the paper body comes in direct contact in the press part in the paper machine, so that, when the paper body sticks to respective members and the paper body separates from above-described respective member, a surface of the paper body ravels, surface strength is prevented from deteriorating due to raveling on a surface of the paper body.

Further, release agent is applied to the dryer roll and/or the canvas with which the paper body comes in direct contact in the dry part in the paper machine, so that, when the paper body sticks to respective members and the paper body separates from above-described respective member, a surface of the paper body ravels, surface strength is prevented from deteriorating due to raveling on a surface of the paper body.

Incidentally, at this time, selection about whether the release agent is applied to only either one of the dryer roll and the canvas or both of them is determined according to the degree of occurrence of raveling on a paper body surface in an actual paper machine (the degree of deterioration of the surface strength of a paper body), of course.

As a result of a further extensive examination, it has been also found that when release agent is applied to respective members in both of the press part and the dry part of the paper machine simultaneously in parallel, raveling on a paper body surface can be prevented from occurring more reliably.

That is, it is more preferable that surface strength is prevented from deteriorating due to raveling on a surface of the paper body occurring when the paper body sticks to respective members and it separates from them by applying release agent to the press roll with coming in direct contact with the paper body in the press part of the paper machine and applying release agent to the dryer roll and/or the canvas coming in direct contact with the paper body in the dry part of the paper machine.

In view of these circumstances, as described above, the method for preventing raveling on a paper body surface of the present invention can be adopted in order to solve a difference in surface strength of a paper body between obverse side and reverse side of the paper body. That is, in paper making by a paper machine, when surface strength of either one face of a felt face and a wire face of a paper body becomes weaker than the other thereof, it is possible to solve the problem of the obverse and reverse difference by applying release agent to the press roll, the dryer roll, or the canvas with which a face with the weaker surface strength of the faces comes in direct contact.

Specifically, for example, when surface strength of a wire face of a paper body becomes weak in a paper machine such as shown in FIG. 1, release agent can be applied to the center roll C, the dryer rolls D2, D4, D6, D8, and the canvas K2 with which the wire face comes in direct contact.

Of course, the method for preventing raveling on a paper body surface of the present invention can be also applied to both faces of the felt face and the wire face of the paper body.

By properly applying the method for preventing raveling on a paper body surface of the present invention in the above manner, raveling prevention of a paper body surface can be achieved totally, and by causing the paper machine to develop inherent ability for forming a paper body surface thereof sufficiently, inherent surface strength to a paper body can be obtained.

Incidentally, there are paper machines of a type where the press rolls P4t and P4b are not provided, namely, the press roll comes in direct contact with only the wire face W2 of a paper body in presently working paper machines, and the obverse and reverse difference of surface strength of a paper body becomes large problematic in these paper machines.

In such a paper machine, surface strength of the wire face of the paper body becomes considerably weaker than the felt face thereof in many case, but the method for preventing raveling on a paper body surface of the present invention is also applicable to only the dry part like the above, and it can develops its effect effectively to reduce or solve the problem of the obverse and reverse difference.

[As Regard Release Agent]

Emulsion of wax or oil, aqueous solution of polymer, solid lubricating agent, or mixture is preferably used as release agent.

As the release agent applied to the press roll, polymer aqueous solution, silicone oil emulsion, or aqueous solution or emulsion containing wax as main component is preferably used.

Of these material, as the polymer, ampholyte polymer obtained by polymerizing mixture of cationic monomer having ethylene double bond and anionic monomer having ethylene double bond contained as an essential component is much excellent in releasability and is preferable.

The cationic monomer having ethylene double bond may include monomer having ethylene double bond with amino groups, ammonium base, or quaternary ammonium base.

Specifically, compounds which are (meta) acrylic esters such as (meta)acrylic acid 2-(N,N-dimethylamino)ethylmethylchloride salt, (meta)acrylic acid 2-(N,N-dimethylamino)ethylbenzylchloride salt, and (meta) acrylic acid 3-(N,N-dimethylamino)propylepichlorohydrin hydrochloride and, which contain quaternary ammonium chlorine can be adopted.

Incidentally, one or more materials selected from these materials are adopted.

(Meta)acrylic acid 2-(N,N-dimethylamino)ethylmethylchloride salt or (meta)acrylic acid 2-(N,N-dimethylamino)ethylbenzylchloride salt is preferable from an effective aspect.

The anionic monomer having ethylene double bond may include monomer having ethylene double bond with carboxyl groups or alkali metal salt thereof.

Specifically, acrylic acid, methacrylic acid, itaconic acid, fumaric acid, succinic acid 2-(meta)acrylicoiloxyethyl, and hexahydrophthalate 2-(meta)acrylicoiloxyethyl, or the like can be adopted.

Incidentally, one or more materials selected from these materials are adopted.

Acrylic acid or methacrylic acid is preferable from an effective aspect.

Further, in view of effect, it is further preferable to polymerizing graphite chain-like material, for example, polyethyleneglycolmono(meta)acrylate and/or polypropyleneglycolmono(meta)acrylate and the like, to the above-described ampholyte polymer as non-ionic (nonion) monomer.

It is more preferable from an effective aspect that the number of carbon atoms is in a range of 6 to 50 in the non-ionic (nonionic) monomer.

Further preferably, material with the number of carbon atoms in a range of 10 to 40 shows higher effect.

Incidentally, it is preferable that the ampholyte polymer includes the cationic monomer in a weight percentage of 40% or more.

Further, silicone oil has a feature that, when the silicone oil is applied to the press roll and the like, it forms a coating film having releasability and repellency inherent to the silicone oil on these members is preferably used.

There are various kinds of silicon oils, but denatured silicone oil such as side chain type amino-denatured silicone oil has a high fixing property to a press roll or a canvas and it is preferable very much.

As the release agent applied to the dryer roll, emulsion containing vegetable oil such as ricinus or colzaoil, mineral oil, synthetic oil, silicone oil, wax a main component is effective.

It is preferable that as the wax has a melting point lower than a surface temperature of the dryer roll.

Further, as the release agent to the canvas, emulsion containing the silicone oil, the vegetable oil and the like described above or the like as a main component is effective.

Wax, oil, polymer, and the like can be used alone or as a mixture of two or more thereof as a main component, and it is usually performed in this technical field to properly select the main component depending on the kind of a paper body to be made or the like, which is possible, of course.

[As Regard Applying Method]

An applying method of release agent depends on a layout of the press roll, the dryer roll, or the canvas, but it is preferable in the constitution example shown in FIG. 1 that respective members are applied with release agent at a position of a spray nozzle S1 shown in FIG. 3, a spray nozzle S2 shown in FIG. 6, or spray nozzles S3, S4 shown in FIG. 1.

Considering various conditions such as a paper making speed of a paper making machine, a width of a paper body, materials for members or the like, a kind or a spaying amount of release agent, a kind of a spraying nozzle, a spraying method and the like can be selected properly.

Specifically, selection is performed from various spraying means such as spraying means provided with a plurality of longitudinal nozzle ports of a fixed type, or spraying means of a sliding type where single or plural nozzles conduct spraying while reciprocating in an axial direction of a roll or the like or a widthwise direction of a canvas.

The kind of the spray nozzle is properly selected from various nozzle types such as a one-fluid nozzle or a two-fluid nozzle so as to correspond to a spraying amount or the like.

Further, when release agent is applied to the press roll P4t, a method where a doctor DR is disposed and emulsion of release agent T is supplied from a doctor shower DS to form pond DP thereby performing application can be also adopted as shown in FIG. 5.

According to this method, such a constitution can be adopted that release agent T leaks little by little from a gap between the press roll P4t and doctor DR and release agent T can be applied on a surface of the press roll P4t uniformly.

[Improvement of Method for Preventing Raveling on Paper Body Surface]

The following matters were further observed in the above experiment for examining occurrence mechanism of raveling on a paper body surface.

[Observation (1)]

First, when all dryer rolls in the dry part were heated, a dryer roll with which a felt face or a wire face of a paper body first came in direct contact was most contaminated by pitches and the like, and dryer rolls subsequent thereto were also contaminated but the degrees of contamination thereto were reduced.

For example, in the dry part D shown in FIG. 1, contamination of the dryer roll D1 with which the felt face of the paper body W came in direct contact and the dryer roll D2 with which the wire face came in direct contact were most exquisite.

Then, the successive dryer rollers were also contaminated, but the degree of contamination was reduced according to further separation from the dryer roll D1 or the D.

[Observation (2)]

On the other hand, there was a case that several dryer rolls adjacent to the press part, namely, several dryer rolls just after a paper body was transfered to the dry part were not heated and downstream side dryer rolls subsequent thereto were heated to make paper.

In this case, the heated dryer roll with which the felt face or the wire face of the paper body first came in direct contact was most contaminated.

Further, a non-heated dryer roll positioned upstream side of this heated dryer roll was contaminated in some cases and it was not contaminated in some cases by the paper machine.

For example, in the dry part D shown in FIG. 1, when a paper was made in a state that the dryer rolls D1 to D4 were not heated but the dryer roll D5 and the dryer rolls subsequent thereto were heated, the heated dryer roll D5 (which came in contact with a felt face of a paper body W) and the dryer roll D6 (which came in contact with a wire face) were most contaminated.

The successive direr rolls were also contaminated but the degree of contamination thereof was reduced according to further separation from the dryer roll D5 or D6.

Furthermore, the non-heated dryer rolls D1 to D4 were contaminated in some cases and they were not contaminated in some cases by the paper machine.

From the above observations (1) and (2), on the heated dryer rolls, it was found that instantaneous burning-out due to heat of the roll described above was strong surprisingly and raveling occurred on a paper body surface due to the burning-out.

Further, it was thought that some of fibers raveled on the paper body surface were deposited on a surface of the roll together with adhesive material such as pitch and adhesive property thereof increased on the heated dryer roll, so that fibers in the vicinity of the surface of the paper body were further strongly pulled, which resulted in deterioration of surface strength of the paper body.

Therefore, as the result of experiment of application of release agent to a dryer roll performed while changing heating conditions variously, it was found that it was unnecessary to apply release agent to all dryer rolls necessarily.

First of all, by applying release agent to the dryer roll D1 with which the felt face of a paper body first comes in contact or the dryer roll D2 with which the wire face of a paper body first comes in contact (see FIG. 1 regarding the both cases), or to the both dryer rolls, function and effect of the present invention were developed sufficiently.

This is considered because a portion of release agent applied to the dryer roll is transferred to a paper body to be conveyed downstream and the a portion is transferred from the paper body to the successive dryer rolls.

For example, when release agent is applied to the dryer roll D1, portion of the release agent applied to the dryer roll D1 is transferred to a felt face of a paper body W to be conveyed, so that the portion is applied to the successive dryer rolls D3, D5, D7 via the paper body W.

Further, when release agent is applied to the dryer roll D2, a portion thereof are conveyed to the succesive dryer rolls D4, D6, D8 via the wire face of the paper body W to be applied thereto.

At this time, the dryer roll D1 and/or D2 may be put in a heated state or may be put in a non-heated state, and similar effect can be developed in both the cases.

Further, when release agent is applied to only a dryer roll with which a paper body first comes in contact in this manner, raveling on a paper body surface can be prevented efficiently by application of a small amount of release agent, which results in an actual applying method in view of cost or the like, which is preferable.

Second, when a non-heated dryer roll positioned upstream side is hardly contaminated, raveling on a paper body surface can be prevented more effectively by applying release agent to a heated dryer roll with which a paper body first comes in contact [corresponding to the dryer roll D5 and/or D6 in the case of the above observation (1)] without applying release agent to the non-heated roller, which is preferable.

In this case, a portion of release agent applied to these dryer rolls is conveyed to downstream dryer rolls via the paper body to be applied thereto efficiently like the above case.

Further, since occurrence of raveling on a paper body surface at a heated first dryer roll which is easy to cause the most exquisite burning-out on the surface of the paper body can be prevented reliably and fiber organization of the paper body surface tightens to some extent due to the heating, burning-out even at the successive dryer rolls is hard to occur.

On the other hand, as previously described, such a case may occur that when a paper body which has entered in the dry part sticks to a canvas and it separates from the canvas, a paper body surface is pulled so that raveling occurs.

Therefore, by applying release agent to not only the canvases K1 and K2 in a first group of the dry part in the paper machine but also canvases of a second group, a third group (not shown), and the like positioned further downstream, raveling can be prevented from occurring more reliably.

In fact, however, since drying of a paper body progress to some extent in the first group of the dry part shown in FIG. 1 and fiber organization of a paper body surface tightens, it is unnecessary to apply release agent to the canvases in the second group and the groups subsequent thereto necessarily.

Accordingly, when release agent is applied to a canvas in application of the method for preventing raveling on a paper body surface of the present invention, the effect of the release agent can be developed sufficiently by applying the release agent to a canvas with which a paper body first comes in direct contact.

[As Regard Kind of Paper Body]

As described above, the present invention has been made based upon such recognition that it is necessary to strengthen surface strength of a paper body in order to solve the problem of the blanket piling, the dry pick, or the wet pick in the offset printing.

Therefore, as a matter of course, the method for preventing raveling on a paper body surface of the present invention achives its effect much effectively when a paper body to be made is a printing paper for offset printing.

However, the present invention is not based upon properties of a printing paper for offset printing but it is applicable to a paper making process for paper products in general without depending on the kinds of paper bodys, as described above.

Further, strong surface strength of a paper body is a quality property required for not only such a printing paper for offset printing but also paper products in general.

Accordingly, the method for preventing raveling on paper body surface of the present invention can be adopted for making various paper products including not only the printing paper for offset printing but also paper for home use such as newsprint paper, enamel paper, wrapping paper, thin paper, toilet roll, tissue paper, so-called foreign paper such as hybrid paper, a so-called paper board such as fiber board, white paperboard, color paperboard, paper core base paper, building material base paper, various boards, or other paper products, and it develops its effect effectively.

[Application for Improvement in Smoothness of Paper Body]

As described above, the method for preventing raveling on paper body surface of the present invention makes it possible to prevent raveling or fuzzing on a paper body surface much effectively by applying the method to a paper making step.

Therefore, according to the present invention, deterioration of smoothness of a paper body due to raveling or fuzzing of the paper body can be prevented and the smoothness can be further improved.

Of course, it is possible to improve smoothness effectively by using the method together with a (soft) calendering process.

Further, it is possible to solve an obverse and reverse difference in smoothness of a paper body and solve an obverse and reverse difference in ink impressibility or the like due to the obverse and reverse difference in smoothness.

Though the present invention has been explained above, the present invention is not limited to the embodiments, and it can be modified variously without departing from the essence of the present invention, of course.

For example, besides the press roll, the dryer roll, and the canvas described in the present invention, of course, release agent can be applied to, for example, felt which comes in direct contact with a paper body or a paper roll guiding a paper body in the press part or a (soft) calender or the like in the dry part.

Further, though not illustrated in FIG. 3 or FIG. 6, of course, it is possible to arrange one or plural doctors in front and in the rear of the spray nozzle (S1 or S2), and it comes near to stating the obvious that such a constitution is adopted properly according to need.

### EXAMPLE

Examples will be described below.

It comes near to stating the obvious that the present invention is not limited to these Examples.

[Paper Making Conditions]

Papermaking kind: poor-quality printing paper [DIP 100%]

Paper width: 3500 mm

Papermaking speed: 650 m/min

Base weight: 50 g/m²

Daily production: 170 t

Incidentally, a press part in a paper machine which conducted papermaking was one of approximately the same type as shown in FIG. 1.

[Release Agent]

As release agent to a press roll, a release agent corresponding to ampholyte copolymer obtained by polymerizing mixture including cationic monomer having ethylene double bond and anionic monomer having ethylene double bond as essential components was used.

That is, specifically, aqueous solution including 2 weight % of aqueous polymer using (meta)acrylic acid 2-(N,N-dimethylamino)ethylbenzylchloride salt as cationic monomer and acrylic acid as anionic monomer as main components was used.

As release agent to a dryer roll, emulsion including total 10 weight % of mineral oil and wax (Dascreen R507NA produced by Mentech Corp.) was used.

As release agent to a canvas, emulsion including 10 weight % of side chain denatured silicone oil (KF-860 produced by Shin-Etsu Chemical Co., Ltd.) was used.

Incidentally, the above emulsions (the release agent to the dryer roll and the canvas) were water-base material, and they contained 2 weight % of emulsifying agent in addition to the above main components.

[Applying Method of Release Agent]

Application of release agent to a center roll C in a press part was performed by spraying the release agent in a state that the release agent was diluted in shower water by the spray nozzle S1 (shown in FIG. 3) to conduct spraying at a rate of 9 cm³/min on a concentrate solution (the above aqueous solution of 2 weight %) base.

Application of release agent to a press roll P4t in the press part was performed by supplying the release agent in a state that the release agent was diluted in shower water by the method shown in FIG. 5 to perform application at a rate of 3 cm³/min on a concentration solution base.

All dryer rolls were used in their heated states, and the release agent was sprayed to the dryer rolls D1 and D2 by the spray nozzle S2 (the sliding type spray device) shown in FIG. 6 in a concentrate solution state of the release agent (emulsion of total 10 weight %) at a rate of 5 cm³ per minute.

Release agent to the canvas was sprayed to out rolls of the canvas at positions S3 and S4 shown in FIG. 1 by a sliding type spraying device in a state that the release agent was in a concentrate solution at a rate of 5 cm³/min, so that the release agent was transferred to the upper and lower canvases K1 and K2 via respective out rolls to be applied thereto.

[Experiment Contents]

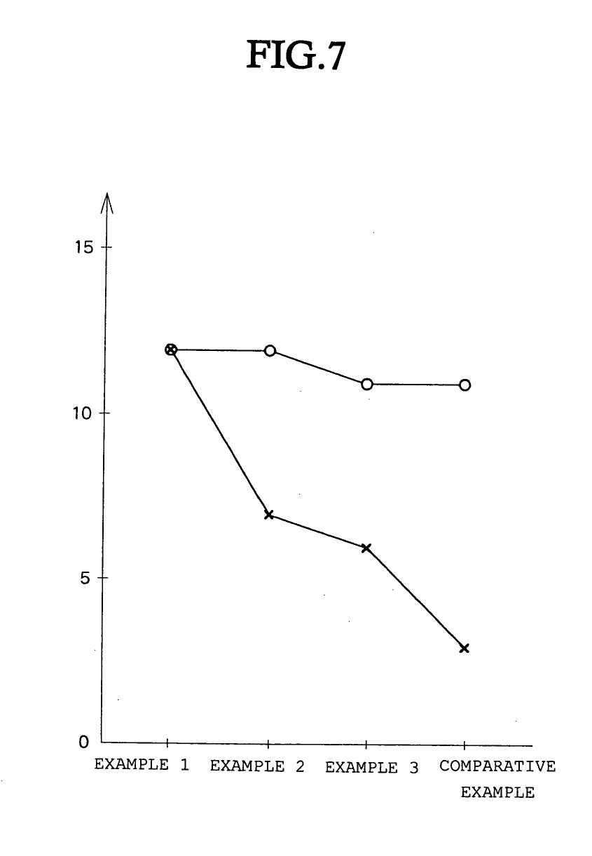

Cleaning cycles (the number of windings) of a blanket when offset printing to poor-quality printing papers made under the application conditions of release agent shown in the following Examples 1 to 3 and Comparative Example are shown with line plots in FIG. 7.

Incidentally, in FIG. 7, O marks show a case that offset printing was performed on a felt face of the poor-quality printing paper and X marks show a case that offset printing was performed on a wire face.

### Example 1

The release agents are applied to the press rolls C and P4t, the dryer rolls D1 and d2, and the canvases K1 and K2.

### Example 2

The release agent is applied to the press rolls C and P4t, but release agent is not applied to the dryer rolls D1 and D2, and the canvases K1 and K2.

### Example 3

The release agent is applied to the dryer rolls D1 and d2, and the canvases K1 and K2, but it is not applied to the press rolls C and P4t.

### Comparative Example

(Blank) The release agent is applied to none of the press rolls, the dryer rolls, the canvases.

[Result and Evaluation]

From the result (see O marks in FIG. 7) of cleaning cycles of a blanket when offset printing was conducted on the felt face, it is found that raveling hardly occur on the felt face of the paper body in a paper machine used in this experiment and surface strength is kept in an excellent state.

It is thought that the reason is because dehydration of a felt face was performed effectively in the press part so that fiber organization in the vicinity of the felt face tightened effectively.

On the other hand, from the result of the wire face (see X marks in FIG. 7), it is found in case of the Comparative Example that the cleaning cycle of the blanket in the offset printing was shortened and the surface strength of the paper body lowered so that blanket piling occurred.

Incidentally, when paper making was performed under the conditions of the Comparative Example, contamination due to fine fibers, pitches or the like on the press roll (the center roll C in FIG. 1) and the upper stage dryer rolls (D2 and the like) in the paper machine was observed.

From the above, it is found that surface strength of the wire face already lowered and raveling started occurring in the stage of the press part or the dry part.

Next, from the results of Examples 2 and 3, the cleaning cycles in both the cases were prolonged as compared with the Comparative Example (blank) and occurrence of blanket piling was suppressed.

That is, it is found that surface strength of a paper body can be elevated to some extent (the degree of deterioration of surface strength can be reduced) by only applying the method for preventing raveling on a paper body surface of the present invention to either one of press part or the dryer part.

In the case of Example 1, a considerably excellent result was obtained, and it is found that surface strength of a paper body can be prevented from deterioration to such an extent that an obverse and reverse difference in surface strength of a paper body can be solved at least in the paper machine by applying the present invention to the both parts of the press part and the dry part like the case of Example 1.

### Additional Experimental Example

Papermaking kind used was a poor-quality printing paper (DIP 100%) and the papermaking conditions, namely, paper width, papermaking speed, base weight, daily production, and the like were identical to those in Examples 1 to 3.

Experiment where three kinds of release agents of release agent A, release agent B, and release agent C were applied to a press roll C in a press part in a paper machine which conducted paper making (approximately the same type shown in FIG. 1) was conducted.

Incidentally, application was conducted to the other press rolls, dry rolls, and canvases like Example 1.

The release agent A was aqueous solution including 2 weight % of aqueous polymer containing copolymer of cationic monomer and anionic monomer (5:5 in weight ratio) as a main component, the release agent B was aqueous solution including 2 weight % of aqueous polymer containing copolymer of cationic monomer and anionic monomer (8:2 in weight ratio) as a main component, the release agent C was aqueous solution including 2 weight % of aqueous polymer containing copolymer of cationic monomer, anionic monomer, and nonionic monomer (4:4:2 in weight ratio) as a main component, and the release agent D was aqueous solution including 2 weight % of aqueous polymer containing copolymer of cationic monomer, anionic monomer, and nonionic monomer (7:2:1 in weight ratio) as a main component Release agent E was aqueous solution including 2 weight % of aqueous polymer containing copolymer of cationic monomer as a main component.

Here,

Cationic monomer; (meta)acrylic acid 2-(N,N-dimethylamino)ethylbenzylchloride salt

Anionic monomer; methacrylic acid

Nonionic monomer; polyethyleneglycolmono (meta) acrylate

As applying method of these release agents to the press roll, each of the release agents was sprayed by the spray nozzle S1 shown in FIG. 3 in a state that the release agent was diluted in shower water to be applied at a rate of 9 cm³/min on a concentrate solution base.

Blanket extraneous matters were observed when offset printing was performed on a wire face of a poor-quality printing paper.

In this case, the number of vessels (fiber foreign matters) whichwere extraneous matters per 100 cm² was observed.

Incidentally, more considerable ravel-preventing effect is shown according to reduction in this value.

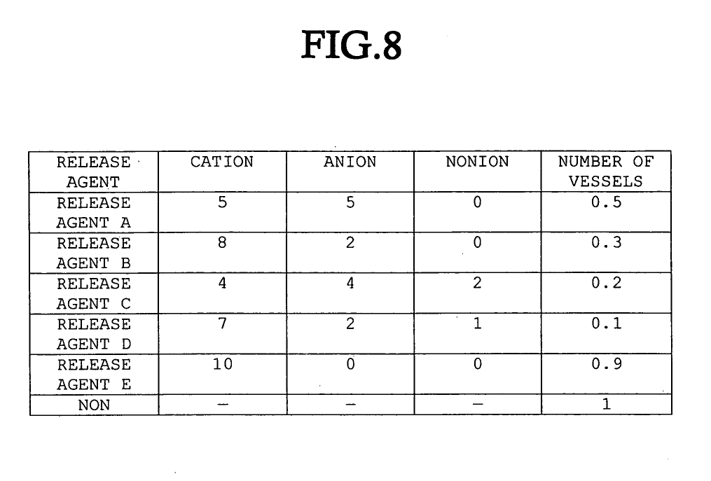

The result is shown in FIG. 8.

Here, the number of vessels was represented in an index manner by defining non-application of release agent to the press roll as 1.

Further, the inventors separately conducted experiment for applying release agent to a felt in a press part and had a similar finding.

Furthermore, the inventors separately conducted experiment for applying release agent to a wire in a wire part and had a similar finding.

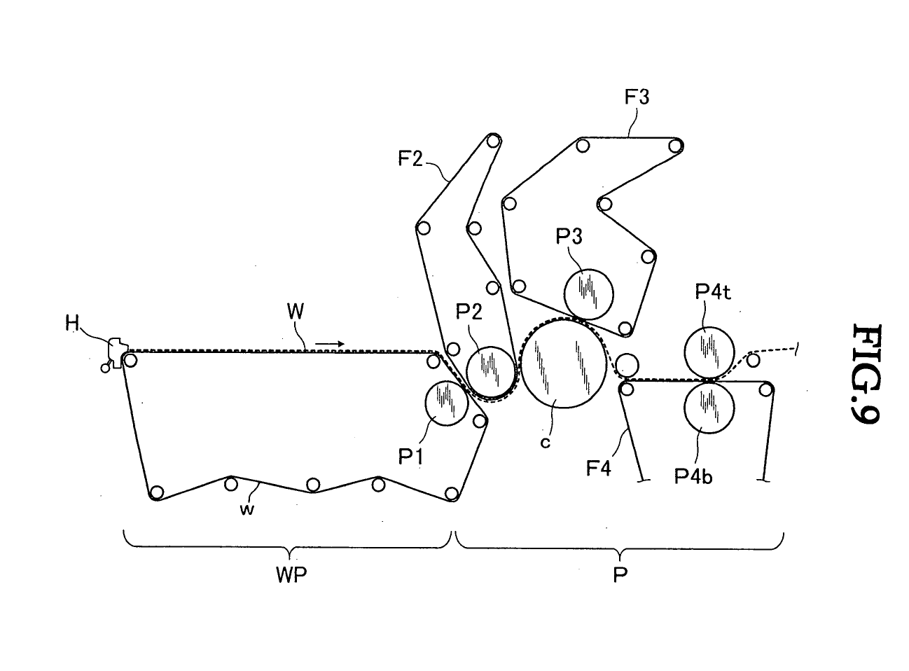

For your reference, the wire part is a region positioned ahead of a press part, as shown in FIG. 9.

Then, a wire w is entrained by guide rolls, and slurry-like pulp supplied from a head box H on to this wire w is placed on the wire in a thin film manner to be conveyed to the press part.

At that time, moisture contained in slurry-like pulp is dehydrated.

### INDUSTRIAL APPLICABILITY

The present invention relates to a method for preventing raveling on a paper body surface in a paper machine, a printing paper for offset printing, and release agent, but it can be applied to an entire field of papermaking techniques without departing from the principle, where similar effect can be expected.

1. A method for preventing raveling on a paper body surface, wherein release agent is applied to a member which comes in direct contact with a paper body in a press part and/or a dry part in a paper machine and surface strength is prevented from deteriorating due to raveling on the paper body surface occurring when the paper body separates from the member.

2. A method for preventing raveling on a paper body surface, wherein release agent is applied to a member which comes in direct contact with a paper body in a wire part in a paper machine and surface strength is prevented from deteriorating due to raveling on the paper body surface occurring when the paper body separates from the member.

3. A method for preventing raveling on a paper body surface, wherein release agent is applied to a press roll which comes in direct contact with a paper body in a press part in a paper machine and surface strength is prevented from deteriorating due to raveling on the paper body surface occurring when the paper body separates from the press roll.

4. A method for preventing raveling on a paper body surface, wherein release agent is applied to a dryer roll and/or a canvas which comes in direct contact with a paper body in a dry part in a paper machine and surface strength is prevented from deteriorating due to raveling on the paper body surface occurring when the paper body separates from each of the above-described members.

5. A method for preventing raveling on a paper body surface, wherein release agent is applied to a press roll which comes in direct contact with a paper body in a press part in a paper machine, release agent is applied to a dryer roll and/or a canvas which comes in direct contact with a paper body in a dry part in the paper machine, and surface strength is prevented from deteriorating due to raveling on the paper body surface occurring when the paper body separates from each of the above-described members.

6. A method for preventing raveling on a paper body surface according to claim 4, wherein above-described dryer roll is a dryer roll with which the paper body first comes in direct contact.

7. A method for preventing raveling on a paper body surface according to claim 4, wherein above-described dryer roll is a heated dryer roll with which the paper body first comes in direct contact.

8. A method for preventing raveling on a paper body surface according to claim 4, wherein above-described canvas is a canvas with which the paper body first comes in direct contact.

9. A method for preventing raveling on a paper body surface according to claim 1, wherein above-described paper body is a printing paper for offset printing.

10. A printing paper for offset printing manufactured using the method for preventing raveling on a paper body surface according to claim 1.

11. Release agent used in the method for preventing raveling on a paper body surface according to claim 1, wherein a main component of the release agent to be applied is wax, emulsion of oil, aqueous solution of polymer, or mixture of these materials.

12. Release agent according to claim 11, wherein above-described oil is silicone oil.

13. Release agent according to claim 11, wherein above-described oil is vegetable oil, mineral oil, synthetic oil, or mixture thereof.

14. Release agent according to claim 11, wherein above-described polymer is ampholyte copolymer obtained by polymerizing mixture including cationic monomer having ethylene double bond and anionic monomer having ethylene double bond as essential components.

15. Release agent according to claim 14, wherein above-described cationic monomer is monomer having ethylene double bond with amino groups, ammonium base, or quaternary ammonium base.

16. Release agent according to claim 14, wherein the anionic monomer is a monomer having ethylene double bond with carboxyl groups or alkali metal salt thereof.

17. Release agent according to claim 11, wherein above-described polymer is ampholyte copolymer obtained by polymerizing mixture including cationic monomer having ethylene double bond, anionic monomer having ethylene double bond, and non-ionic (nonion) monomer as essential components.

18. Release agent according to claim 15, wherein above-described cationic monomer is at least one selected from the group consisting of compounds which are (meta)acrylic acid esters such as (meta)acrylic acid 2-(N,N-dimethylamino)ethylmethylchloride salt, (meta)acrylic acid 2-(N,N-dimethylamino)ethylbenzylchloride salt, and (meta) acrylic acid 3-(N,N-dimethylamino)propylepichlorohydrin hydrochloride and which contain quaternary ammonium chlorine.

19. Release agent according to claim 16, wherein above-described anionic monomer is at least one selected from the group consisting of acrylic acid, methacrylic acid, itaconic acid, fumaric acid, succinic acid 2-(meta)acrylicoiloxyethyl, and hexahydrophthalate 2-(meta)acrylicoiloxyethyl.

20. Release agent according to claim 17, wherein the number of atoms is in a range of 6 to 50 in above-described non-ionic (nonionic) monomer.

21. Release agent according to claim 17, wherein above-described non-ionic (nonionic) monomer is polyethyleneglycolmono (meta)acrylate and/or polypropyleneglycolmono(meta)acrylate.
